(19) United States
(12) Patent Application Publication
(10) Pub. No.: US 2004/0202608 A1
(43) Pub. Date: Oct. 14, 2004

(54) Method for the precipitation of poorly-soluble materials such as barium sulphate for example and precipitation capsule

(76) Inventor: Udo Selter, Moers (DE)

Correspondence Address: FULBRIGHT & JAWORSKI, LLP, 666 FIFTH AVE, NEW YORK, NY, 10103-3198, US

(21) Appl. No.: 10/485,227

(22) PCT Filed: Jun. 11, 2002
(86) PCT No.: PCT/EP02/07713

(30) Foreign Application Priority Data
Jul. 31, 2001 (DE) 101 37 325.2

(51) Int. Cl. B01D 9/00

(52) U.S. Cl. 423/659

(57) ABSTRACT

The invention relates to a precipitation method and corresponding precipitation capsules for the precipitation of poorly-soluble materials such as barium sulphate for example, whereby the desired poorly-soluble material is obtained by mixing two individual components in a precipitation capsule and reaction together of said individual components. According to the invention, precipitates with defined particle sizes in the range from 0.1-2 μm with high throughput may be achieved, whereby the precipitation is carried out continuously in one of the precipitation capsules with differing precipitation volumes (residence times) with subsequent homogenisation in a static mixer.

The invention relates to a method for the precipitation of poorly soluble materials, such as barium sulphate for example, in which the desired poorly soluble material is formed by mixing together two individual components in a precipitation capsule as a result of a reaction of the individual components one with the other.

In accordance with the reaction equation 1, 2, 3 or 4 (see below) barium sulphate (BaSO₄) is produced by precipitation from barium sulphide (BaS) or barium chloride (BaCl₂) with sodium sulphate solution (Na₂SO₄) or sulphuric acid (H₂SO₄) respectively or from barium hydroxide solution (Ba(OH)₂) with sulphuric acid (H₂SO₄).

BaS+Na₂SO₄→BaSO₄+Na₂S 1.

BaCl₂+Na₂SO₄→BaSO₄+2 NaCl 2.

BaCl₂+H₂SO₄→BaSO₄+2 HCl 3.

Ba(OH)₂+H₂SO₄→BaSO₄+2 H₂O 4.

In order to obtain a desired grain size (average particle diameter, also called median value (d₅₀)) and a desired grain distribution, the precipitation, that is, the bringing together of the precipitation solutions as individual components, must be effected in a certain way in a certain precipitation apparatus. The residence time in the precipitation apparatus is of crucial significance as one of the main parameters. Further important precipitation parameters are the concentration and the temperature of the precipitant solutions.

In general, the following holds:

high temperature (up to 80° C.) and low concentration (approximately 5% solutions)=coarse particles; low temperature (approximately 30° C.) and high concentration (>15% solutions)=fine particles.

small precipitation volume with short residence time (<1 sec) in the precipitation apparatus=fine particles; large precipitation volume with long residence time (up to one hour)=coarse particles.

The object consisted in simplifying the precipitation method and thus the associated precipitation apparatus through new design, as far as possible as a closed apparatus without a stirring mechanism and built-in/built-on parts, so that the required grain fineness (median value d₅₀) can be established in the range of 0.1 to 2 μm in a reproducible and lasting manner with a high BaSO₄-throughput (t/h).

It was found that the product fineness demanded by the market—judged according to the median value d₅₀—can only be realized with precipitation apparatus (precipitation capsules) that are of differing magnitudes in terms of precipitation volume, in combination with downstream static mixers.

In accordance with the invention, it is therefore proposed with regard to the method that the precipitation is effected continuously in precipitation capsules which are of differing precipitation volumes and are connected in parallel, with subsequent homogenization in the respective static mixer.

Expediently, the precipitation capsules have a respective feed, which can be shut off, for each individual component with a respective free outlet into the static mixer which opens/open into a common discharge line.

The precipitation volume of the various precipitation capsules is crucial when selecting which apparatus is used for the required product fineness.

A precipitation capsule in accordance with the invention for use in the method that has just been described is distinguished by virtue of the fact that each precipitation capsule has a feed for an individual component in the axial direction of the precipitation capsule and a feed for the other individual component tangentially or at an acute angle to the longitudinal axis of the precipitation capsule.

The precipitation capsules are preferably made from plastics material.

The precipitation capsules (precipitation volume <1 to 100 l) are closed, round, cylindrical precipitation apparatus with a conical feed and outlet. A further feed for the second precipitation component is arranged at the side.

These apparatus are preferably made from plastics material. The two precipitation components are in each case supplied separately by way of line systems which are connected to pumps. The volume flows of solution containing barium and sulphate reach the respective capsule in part by way of liquid distributors axially and tangentially, with barium sulphate being precipitated spontaneously which, under low pressure as a precipitation suspension, reaches the tubular mixer (static mixer) and from there by way of a common discharge line reaches the so-called precipitation vessel (which in this case serves as a receiver vessel).

The residence time in the respective precipitation apparatus is dependent upon the precipitation magnitude (precipitation volume) of the capsule and the speed of precipitation (volume flow (m³/h)) of the precipitant solutions.

By means of corresponding variation, that is, size of the precipitation capsule, with otherwise unchanged precipitation parameters (essentially concentration and temperature) each desired grain size (median value d₅₀ in the range of 0.1 to 2 μm) can be set in a reliable manner.

The varyingly high precipitation speed in the respective precipitation capsule at the same time ensures that there is spontaneous intensive mixing of the precipitation components so that viewed in terms of reaction kinetics no local concentration gradients develop during the precipitation that negatively affect the grain spectrum/median value d₅₀ in an undesirable manner.

The crucial criterion, however, is that the reaction components only come into contact with each other shortly before entering the respective precipitation capsule—in the zone of maximum turbulence—and the precipitation suspension thus produced is homogenized further in a unified manner in the downstream tubular mixer so the precipitation has terminated practically before inflow into the actual precipitation vessel.

Previous experience has shown that the grain fineness changes only insignificantly during the rest of the process run. The capsules used in accordance with the invention are, for example, also suitable for producing barium carbonate, barium chromate and zinc sulphide.

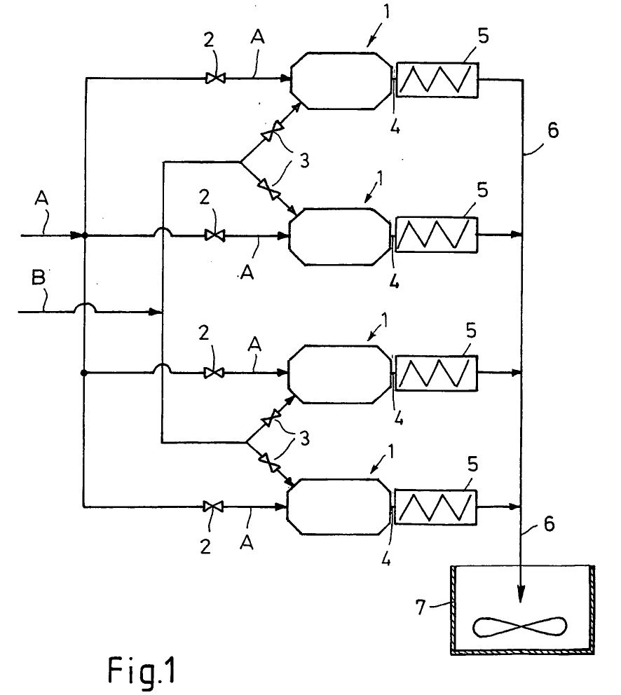

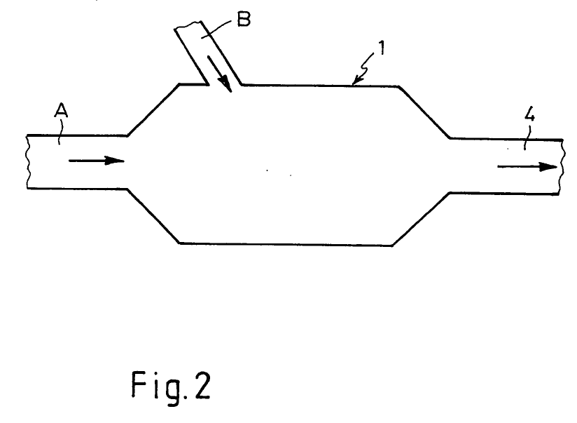

Further features of the invention follow from FIGS. 1 and 2 which are described below.

FIG. 1 shows a plurality of precipitation apparatus (precipitation capsules) in the composite system for the precipitation of poorly soluble materials, such as barium sulphate for example. The reference numeral 1 denotes precipitation capsules which each have a different precipitation volume, depending on the desired product fineness. Each precipitation capsule 1 has a feed A for the first individual component that can be shut off by a valve (characterised by 2) and a feed B for the second individual component that can be shut off by a valve (characterised by 3). A static mixer 5 with a free feed and outlet belongs to each precipitation capsule 1, with the respective discharges reaching, by way of a common line 6, the so-called precipitation vessel 7 which in this case is the receiver vessel for the further process step.

By varying the precipitation volume of the individual precipitation capsules 1 in an appropriate manner, with otherwise unchanged precipitation parameters, each desired grain or product fineness can be set in a reliable manner in the range of 0.1-2 μm.

FIG. 2 showed (sic) an individual precipitation capsule 1 with a feed A, a feed B and an outlet 4. The feed A into the precipitation capsule 1 is effected axially and the feed B is effected tangentially or at an acute angle. The precipitation capsules 1 are preferably made from plastics material.

1-5. (canceled)

6. A method for the precipitation of poorly soluble materials, comprising forming the desired poorly soluble material by mixing together two individual components in at least two precipitation capsule to react the individual components one with the other to form the desired poorly soluble material, wherein precipitation capsules of differing precipitation volumes are connected in parallel, in each case with a downstream static mixer, and the precipitation is effected continuously in just one of the precipitation capsules, which are connected in parallel, with subsequent homogenization in the associated static mixer, with the precipitation capsule that is to be used being selected in accordance with the product fineness that is required.

7. The method according to claim 6, wherein the precipitation capsules have a respective feed (A, B), which can be shut off, in part with and without a liquid distributor for each individual component and a respective free outlet into the static mixer.

8. A precipitation capsule comprising a feed (A) for an individual component in the axial direction of the precipitation capsule and a feed (B) for the other individual component at an acute angle to the longitudinal axis of the precipitation capsule.

9. A precipitation capsule of claim 7, wherein the precipitation capsule has a feed (A) for an individual component in the axial direction of the precipitation capsule and a feed (B) for the other individual component at an acute angle to the longitudinal axis of the precipitation capsule.

10. A precipitation capsule according to claim 8, comprising a media-resistant material.

11. A precipitation capsule according to claim 10, wherein said media-resistant material is a plastic.
